(19) United States
(12) Patent Application Publication
(10) Pub. No.: US 2010/0021731 A1
(43) Pub. Date: Jan. 28, 2010

(54) MULTILAYER FILM FOR USE IN PRISM SHEET, METHOD FOR PRODUCING THE SAME, PRISM SHEET AND DISPLAY DEVICE

(75) Inventors: Tatsuya Nomura, Minami-ashigara-shi (JP); Katsuyoshi Suzuki, Minami-ashigara-shi (JP); Takashi Kobayashi, Minami-ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/508,981

(22) Filed: Jul. 24, 2009

(30) Foreign Application Priority Data
Jul. 25, 2008 (JP) 2008-192221

(51) Int. Cl. B32B 7/12; B32B 37/00

(52) U.S. Cl. 428/354; 156/60; 428/480

(57) ABSTRACT

A prism sheet is composed of a base layer made from polyester, an adhesion layer formed on one of the surfaces of the base layer, a back layer formed on the other surface of the base layer, and a prism layer formed on the adhesion layer. A main constituent of the back layer is water-insoluble polymer with glass transition temperature (Tg) of at least 90° C. Average reflectivity of the back layer is at most 3.5% at wavelength in a range from 380 nm to 780 nm. By containing water-insoluble polymer with Tg of at least 90° C. as the main constituent, the back layer becomes free from contact damage caused by contact with the prism peaks of the adjacent prism sheet. Setting the average reflectivity of the back layer to at most 3.5% imparts brightness enhancement properties to the prism sheet.

### FIELD OF THE INVENTION

The present invention relates to a multilayer film suitably used as a component of a prism sheet such as a prism lens sheet incorporated in a liquid crystal display (LCD), a method for producing the same, a prism sheet and a display device.

### BACKGROUND OF THE INVENTION

Polyester films, in particular, biaxially oriented polyester films are widely used as various optical films due to excellent transparency, dimension stability, chemical resistance and low moisture absorbency. For example, in LCDs, the polyester films are used as base films such as prism sheets, antireflection sheets, diffusion sheets, and hard coated sheets. In plasma displays, the polyester films are used as IR absorption sheets, electromagnetic wave shielding sheets, toning sheets, antireflection sheets, antiglare sheets, and hard coated sheets.

A polyester film (hereinafter may referred to as base) for use in a prism sheet in an LCD is provided with a prism layer on one of its surfaces. This prism layer is made from UV cure polymer or the like. The prism layer needs to be adhered to the polyester film. In general, however, when placed directly above the polyester film, the prism layer may not be sufficiently adhesive. For this reason, a coating layer called an adhesion layer is provided on the polyester film, and then the prism layer is applied thereon. For example, Japanese Patent Laid-Open Publication No. 2001-294826 describes an adhesion layer containing polyester as a binder. Japanese Patent Laid-Open Publication No. 2000-229395 describes an adhesion layer containing polyester and urethane as the binder.

A protection layer, an anti-Newton ring prevention layer or the like can be provided on a back surface of the polyester film, that is, the surface opposite to the prism layer. However, manufacturers give higher priority to cost reduction than providing function layers such as a protection layer to the polyester films. Therefore, in most cases, the back surface of the base is exposed to air (unprotected), or the adhesion layer used for adhering the prism layer to the base is also provided on the back surface of the base.

In a case that the back surface of the base is exposed to air, the brightness enhancement properties thereof are reduced because a biaxially stretched polyester film has a higher refractive index in the plane direction, that is, in the stretch direction, resulting in high reflectivity properties. Transmittance of backlight incident from the back surface is reduced due to the high reflectivity properties of the back surface.

On the other hand, in a case that the adhesion layer is also provided on the back surface of the base, reduction in surface reflectivity and increase in transmittance are expected, because the refractive index of the adhesion layer is normally lower than the refractive index of the base in the plane direction. For example, in Japanese Patent Laid-Open Publication No. 2007-055217, an adhesion layer having a low refractive index is applied onto both surface of the polyester film to obtain relatively high transmittance and brightness enhancement properties.

A polyester film becomes charged with relative ease. In particular, the polyester film for use in a lens sheet such as the prism sheet in the LCD tends to become charged, for example, when a protection sheet covering the lens sheet is peeled off. Upon being charged, the lens sheet adsorbs foreign matter such as dust and dirt by static electricity. Since the adsorbed dust and dirt deteriorate optical properties and appearance of the polyester film, it is preferable to eliminate them as much as possible. Technological suggestions have been made to solve various inconveniences caused by charging of the lens sheet.

For example, in Japanese Patent Laid-Open Publication No. 8-286004, antistatic treatment is applied to at least one of the surfaces of the lens sheet. In Japanese Patent Laid-Open Publication No. 11-023815, surface resistance of a lens layer in a lens sheet is reduced to a predetermined value or less by making the lens layer from polymer composition in which conductive fine particles are dispersed. In Japanese Patent Laid-Open Publication No. 11-202104, a conductive layer is provided on a lens film.

Two prism sheets are usually used in piles, namely, one is stacked on top of the other in a backlight of a thin-profile LCD. As a result, a clearance between the two prism sheets becomes particularly narrow. Two prism sheets are overlaid with each other such that prism peaks of the prism sheet contacts with an adhesion layer of a back surface of the other prism sheet. In a case that the two prism sheets described in Japanese Patent Laid-Open Publication No. 2007-055217 are used in piles, contact damage caused by the prism peaks of the adjacent prism sheet remains with time on the adhesion layer on the back surface side of the prism sheet. Such damage is regarded as streak-like defects, and adversely effects display properties of the LCD.

As for a prism sheet described in Japanese Patent Laid-Open Publication No. 2007-055217, a sufficiently low refractive index cannot be expected due to necessity to ensure adhesion properties. As a result, sufficient brightness enhancement properties cannot be obtained. On the contrary, to achieve a low refractive index, the composition of the adhesion layer is limited. As a result, it becomes difficult for the adhesion layer to exert sufficient adhesion properties to various prism layers. Similar to the Japanese Patent Laid-Open Publication No. 2007-055217, the prism sheets described in Japanese Patent Laid-Open Publication No. 8-286004 may be damaged due to contact with the prism peaks of the adjacent prism sheet when used in piles. Although the lens sheets described in Japanese Patent Laid-Open Publications No. 11-023815 and No. 11-202104 have antistatic properties, their back surfaces have high reflectivity properties. As a result, sufficient brightness enhancement properties cannot be expected.

### SUMMARY OF THE INVENTION

In view of the foregoing, an object of the present invention is to provide a multilayer film that is sufficiently adhesive to various prism layers, for use in a prism sheet, a method for producing the same, a prism sheet, and a display device.

Another object of the present invention is to provide a multilayer film for use in a prism sheet, a prism sheet and a display device that are free from streak-like contact damage caused by contact with prism peaks, and a method for producing such multilayer film.

Still another object of the present invention is to provide a multilayer film for use in a prism sheet, a prism sheet, and a display device that have brightness enhancement properties, and a method for producing such multilayer film.

Further another object of the present invention is to provide a multilayer film for use in a prism sheet, a prism sheet, and a display device that have antistatic properties, and a method for producing such multilayer film.

In order to achieve the above and other objects, a multilayer film for use in a prism sheet according to the present invention has a biaxially-stretched base layer made from polyester, an adhesion layer adhesive to a prism layer and provided on a surface of the base layer, and a back layer provided on the other surface of the base layer. The back layer contains water-insoluble thermoplastic polymer as a main constituent, and the glass transition temperature (Tg) of the thermoplastic polymer is at least 90° C.

It is preferable that the back layer has average reflectivity of at most 3.5% at a wavelength range from 380 nm to 780 nm. It is preferable that a refractive index n of the back layer is at least 1.20 and at most 1.51.

It is preferable that at least one of the back layer and the adhesion layer has conductivity expressed in terms of surface resistance of at most 10¹² Ω/□. It is preferable that at least one of the back layer and the adhesion layer contains metal oxide particles. It is preferable that at least one of the back layer and the adhesion layer contains conductive polymer.

It is preferable that the metal oxide particles are acicular SnO₂ particles, a ratio of a longer-axis length to a shorter-axis length of the metal oxide particles is preferably at least 3 and at most 50. It is preferable that the conductive polymer is π electron conjugated conductive polymer and polythiophene polymer.

It is preferable that the back layer is composed of plural portions overlaid in layers in a thickness direction, and an outermost portion of the back layer is exposed to air and has a refractive index n of at least 1.20 and at most 1.51. It is preferable that the back layer is composed of an antistatic portion and a low refractive index portion. The antistatic portion is layered on the other surface of the base layer. The low refractive index portion is layered on the antistatic portion. It is preferable that the antistatic portion has conductivity expressed in terms of surface resistance of at most 10¹² Ω/□, and the low refractive index portion is the outermost portion.

A method for producing a multilayer film for use in a prism sheet having a prism layer has a preparing step and an applying step. In the preparing step, a biaxially-stretched base layer made from polyester is prepared. In the applying step, an adhesion layer adhesive to the prism layer is applied onto one of surfaces of the base layer, and a back layer is applied onto the other surface of the base layer. The back layer contains water-insoluble thermoplastic polymer as a main constituent, and glass transition temperature (Tg) of the thermoplastic polymer is at least 90° C.

A prism sheet according to the present invention has the prism layer provided on the adhesion layer of the multilayer film for use in the prism sheet. A display device according to the present invention incorporates the multilayer film for use in the prism sheet.

According to the present invention, the back layer is provided on the other surface of the base, and contains the water-insoluble thermoplastic polymer having the glass transition temperature (Tg) of at least 90° C. as a main constituent. As a result, the back layer of the prism sheet becomes free from the contact damage caused by the contact with the prism peaks of the other prism sheet in a case that two prism sheets are used in piles, namely, one is stacked on top of the other. At least one of the back layer and the adhesion layer has the conductivity expressed in terms of surface resistance of at most 10¹² Ω/□, preventing the prism sheet from adsorbing dust and dirt.

### BRIEF DESCRIPTION OF THE DRAWINGS

The above objects and advantages of the present invention will become more apparent from the following detailed description when read in connection with the accompanying drawings, in which:

FIG. 1 is a cross-sectional view of an essential part of a multilayer film for use in a prism sheet according to a first embodiment;

FIG. 2 is a cross-sectional view of an essential part of the prism sheet of the first embodiment;

FIG. 3 is a cross-sectional view of glass plates and a load used for generating contact damage on a back layer by direct contact with prism peaks, and the prism sheet having the back layer of a single layer structure;

FIG. 4 is a cross-sectional view of an essential part of a multilayer film for use in a prism sheet according to a second embodiment;

FIG. 5 is a cross-sectional view of an essential part of the prism sheet of the second embodiment; and

FIG. 6 is a cross-sectional view of glass plates and a load used for generating contact damage on a back layer by direct contact with prism peaks, and the prism sheet having the back layer of a two-layer structure.

### DESCRIPTION OF THE PREFERRED EMBODIMENTS

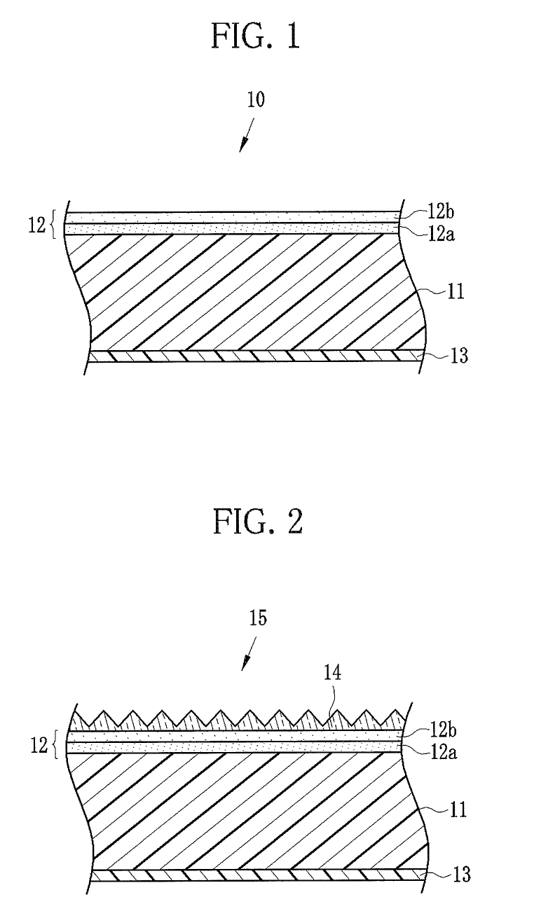

As shown in FIG. 1, a multilayer film 10 for use in a prism sheet according to a first embodiment of the present invention is composed of a base layer 11, an adhesion layer 12, and a back layer 13. The adhesion layer 12 is formed on one of the surfaces of the base layer 11. The back layer 13 is formed on the other surface of the base layer 11.

As shown in FIG. 2, a prism sheet 15 according to the first embodiment of the present invention is composed of the multilayer film 10 and a prism layer 14 formed on the adhesion layer 12 of the multilayer film 10. Two prism sheets 15 are used in piles, namely, one is stacked on top of the other, and incorporated in a display device such as a liquid crystal display (LCD). The two prism sheets 15 are stacked such that prism peaks and grooves between the prism peaks of the prism sheet 15 are orthogonal to those of the other prism sheet 15.

[Base Layer]

The base layer 11 is made from polyester. The polyester is not particularly limited. Examples of polyester include polyethylene terephthalate, polyethylene naphthalate, polybutylene terephthalate, and polybutylene naphthalate. Of those, polyethylene terephthalate is preferable in view of cost and mechanical strength.

To improve mechanical strength, it is preferable that the base layer 11 has been stretched. It is especially preferable that the base layer 11 has been biaxially stretched. In other words, it is preferable to use the stretched or biaxially-stretched base layer 11. A stretch ratio is not particularly limited. However, the stretch ratio is preferably at least 1.5 times and at most 7 times the original size, and more preferably at least 2 times and at most 5 times. It is especially preferable to stretch the base layer 11 at the same stretch ratio, for example, at least 2 times and at most 5 times both in the horizontal and vertical directions. Biaxially stretching the base layer 11 within the above stretch ratio imparts sufficient mechanical strength thereto, and makes the thickness of the base layer 11 uniform.

The thickness of the base layer 11 is preferably at least 20 μm and at most 400 μm, more preferably at least 35 μm and at most 350 μm, and furthermore preferably at least 50 μm and at most 250 μm. The base layer 11 with the thickness within the above range obtains sufficient hardness and is easy to handle, and does not hinder miniaturization of a display device and thus advantageous in cost.

[Adhesion Layer]

The adhesion layer 12 has a two-layer structure of a first portion 12a and a second portion 12b in the thickness direction. The first portion 12a is adhesive to the base layer 11. The second portion 12b is adhesive to the prism layer 14. A layer thickness of the adhesion layer 12, that is, the total thickness of the first portion 12a and the second portion 12b is preferably at least 20 nm and at most 300 nm, and more preferably at least 40 nm and at most 200 nm. By making the thickness of the adhesion layer 12 within the above range, sufficient adhesion between the adhesion layer 12 and the prism layer 14 is obtained without coloring caused by interference of light.

The first portion 12a contains polymer such as polyester having affinity to the base layer 11 as a binder. Polyester is a generic name for polymer having ester bonds in a main chain, and is normally obtained by a reaction between dicarboxylic acid and diol. Examples of dicarboxylic acid include fumaric acid, itaconic acid, adipic acid, sebacic acid, terephthalic acid, and isophthalic acid. Examples of diol include ethylene glycol, propylene glycol, glycerin, and hexanetriol. Polyester and its materials are described in, for example, “Polyester resin handbook” (Eiichiro TAKIYAMA, published by Nikkan Kogyo Shinbunsha, 1988). It is more preferable to use naphthalenedicarboxylic acid as a constituent of the dicarboxylic acid. Owing to naphthalene rings contained in naphthalenedicarboxylic acid, a refractive index of the first portion 12a is improved as a coating layer, and coloring caused by interference of light is reduced in the adhesion layer 12 of the two-layer structure. In addition, oligomer precipitation on (in) the base layer 11 is prevented.

The second portion 12b contains polymer having affinity to the prism layer 14 as a binder. Since the prism layer 14 contains a large amount of acrylic-type UV cure polymer, acrylic polymer having affinity thereto is preferably used as the binder of the second portion 12b, and polyurethane is more preferably used. A mixture or dispersion of acrylic polymer and polyurethane may be used as the binder for the second portion 12b.

Acrylic polymer is obtained by polymerizing acrylic acid, methacrylic acid, or their derivatives as a constituent. To be more specific, acrylic polymer is synthesized by polymerization of, for example, acrylic acid, methacrylic aid, methyl methacrylate, ethyl acrylate, butyl acrylate, 2-ethyl hexyl acrylate, acryl amid, acrylonitrile, or hydroxyl acrylate as a main constituent, and monomer, for example, styrene, divinyl benzene, or the like that is polymerizable with the main constituent.

Polyurethane is a generic name for polymer having urethane bonds in a main chain, and normally synthesized by a reaction between polyisocyanate and polyol. Examples of polyisocyanate include TDI (toluene diisocyanate), MDI (methylene diphenyl diisocyanate), NDI (naphthalene diisocyanate), TODI (tolidine diisocyanate), HDI (hexamethylene diisocyanate) and IPDI (isophorone diisocyanate). Examples of polyol include ethylene glycol, propylene glycol, glycerin, and hexanetriol. In the present invention, isocyanate can be polymer with increased molecular weight, made by chain-extension process to polyurethane polymer synthesized by the reaction between polyisocyanate and polyol. The isocyanate, the polyol and the chain-extension process are described in “Polyurethane resin handbook” (edited by Keiji IWATA, published by Nikkan Kogyo Shinbunsha, 1987), for example.

The above-described polymer dissolved in an organic solvent or dispersed in water (water dispersion) can be used as the binder for the first portion 12a and the second portion 12b. To reduce environmental load, it is preferable to apply water-based emulsion coating of the water dispersion. Following commercially available polymer can be used as the water dispersion: SUPERFLEX 830, 460, 870, 420, 420NS (tradenames, polyurethanemanufactured by Dai-ichi Kogyo Seiyaku Co., Ltd.), HYDRAN AP-40F, WLS-202, HW-140SF (trade names, polyurethane manufactured by Dainippon Ink And Chemicals Inc.), Olestar UD500, UD350 (trade names, polyurethane manufactured by Mitsui Chemicals Inc.), JURYMER ET325, ET410, SEK301 (trade names, acryl manufactured by Nihon Junyaku Co., Ltd.), VONCOAT R3380E, SFA-33 (trade names, acryl manufactured by Dainippon Ink And Chemicals Inc.), NEOCRYL XK-12, XK-220 (trade names, acryl manufactured by Kusumoto Chemicals, Ltd.), FINETEX ES650, ES2200 (trade names, polyester manufactured by Dainippon Ink And Chemicals Inc.), VYLONAL MD1400, MD1480 (trade names, polyester manufactured by Toyobo Co., Ltd. ) and PLAS COAT Z-221, Z-561, Z-730, RZ-142, Z-687 (trade names, polyester manufactured by Goo Chemical Co., Ltd.)

The molecular weight of polymer used as the binder for the first portion 12a and the second portion 12b is not particularly limited. In general, however, it is preferable to use polymer with weight average molecular weight of at least 2000 and at most 1000000. By making the weight average molecular weight within the above range, sufficient strength of the coating layer (adhesion layer 12) is ensured and the surface conditions thereof become excellent.

It is preferable to add a compound containing a plurality of carbodiimide structures in a molecule to the adhesion layer 12 (both in the first portion 12a and the second portion 12b). The compound (hereinafter may be referred to as carbodiimide compound) is not particularly limited as long as it has a plurality of carbodiimide groups in a molecule. The adhesion layer 12 containing carbodiimide compound is excellent in reactivity with ends of carboxylic groups of polyester film as the base layer 11, and increases adhesion with the prism layer 14. The reason thereof is assumed to be due to decrease in modulus of elasticity.

Polycarbodiimide is normally synthesized by condensation of organic diisocyanate. Organic groups of organic diisocyanate used in synthesis of the carbodiimide compound are not particularly limited. Aromatic groups, aliphatic groups or a combination of them can be used. In view of reactivity, aliphatic groups are especially preferable.

Organic isocyanate, organic diisocyanate, organic triisocyanate, or the like can be used as materials for synthesis. Examples of organic isocyanate include aromatic isocyanate, aliphatic isocyanate, and a combination of them.

To be more specific, 4,4′-diphenylmethane diisocyanate, 4,4′-diphenyldimethylmethane diisocyanate, 1,4-phenylene diisocyanate, 2,4-tolylen diisocyanate, 2,6-tolylen diisocyanate, hexamethylene diisocyanate, cyclohexane diisocyanate, xylylene diisocyanate, 2,2,4-trimethyl hexamethylene diisocyanate, 4,4′-dicyclohexylmethane diisocyanate, 1,3-phenylene diisocyanate, and the like can be used. Examples of organic monoisocyanate include isophorone isocyanate, phenyl isocyanate, cyclohexyl isocyanate, butyl isocyanate, and naphthyl isocyanate. Commercially available products, for example, Carbodilite V-02-L2, V-02, and V-04 (trade names, manufactured by Nisshinbo Chemical, Inc.) can be used as the carbodiimide compound of the present invention.

It is preferable to add the carbodiimide compound to the adhesion layer 12 in a range from 1 mass % to 200 mass %, and more preferably, from 5 mass % to 100 mass % relative to the binder in the adhesion layer 12. Adding the carbodiimide compound within the above range to the adhesion layer 12 imparts sufficient adhesion properties and makes the surface conditions excellent.

[Back Layer]

In view of preventing reflection, it is preferable that the back layer 13 has refractive index of at least 1.20 and at most 1.51 at the wavelength of 550 nm. It is more preferable that the refractive index is at least 1.28 and at most 1.50. It is preferable that average reflectivity in the visible light region (380 nm to 780 nm wavelength) is at most 3.5%. Setting the refractive index of the back layer 13 within the range of at least 1.20 and at most 1.51 or the range of at least 1.28 and at most 1.50, the average reflectivity is reduced to at most 3.5% without technical difficulties. As a result, sufficient brightness enhancement properties are obtained. In particular, in a case that the refractive index of the back layer 13 is set to 1.28, the average reflectivity is surely reduced to at most 3.5%. As a result, the back layer 13 exhibits extremely high brightness enhancement properties.

The layer thickness of the back layer 13 is preferably in a range of at least (550/(4n))−40 nm, and at most(550/(4n))+40 nm, and more preferably in a range of at least (550/(4n))−30 nm and at most (550/(4n))+30 nm. Here, “n” is a refractive index of the back layer 13. By making the layer thickness within the above range, the back layer 13 exhibits sufficient low-reflection properties without conspicuous coloring.

A binder is thermoplastic polymer that is a main constituent of the back layer 13. The binder is preferably acrylic polymer, polyolefin, polyurethane, silicone, fluorine polymer, or the like not containing heterocyclic rings and aromatic rings. The glass transition temperature (Tg) of the binder is preferably at least 90° C., and more preferably at least 100° C. With the use of acrylic polymer or the like not containing heterocyclic rings and aromatic rings and by setting its Tg to at least 90° C. or 100° C., damage (streak-like grooves) caused by the prism peaks of the adjacent prism sheet does not remain with time on the back layer 13 of the prism sheet in high temperature environments even if two prism sheets are used in piles. Hereinafter, the streak-like grooves may be referred to as contact damage. This contact damage may become one of the factors that deteriorate display properties of the LCD. However, the deterioration of display properties is prevented by setting the Tg to at least 90° C.

The binder of the back layer 13 is water-insoluble, which prevents the contact damage from remaining on the back layer 13 even in high humidity environments of 80% RH or more.

A water-insoluble binder is preferably, for example, polymer soluble to an organic solvent. Environmentally, latex polymer that is a water dispersion of a water-insoluble polymer is preferable. Examples of latex polymer include co-polymerized polyester, aromatic polyurethane, and acrylic copolymer.

To lower the average reflectivity of the back layer 13, it is preferable to select a material with a low refractive index. Acrylic polymer with a high MMA (methyl methacrylate) content is especially preferable. To eliminate the possibility of the contact damage remaining on the back layer 13, it is necessary that the back layer 13 contains water-insoluble polymer with high Tg as a main constituent. Thereby, the multilayer film for use in the prism sheet of the present invention maintains low average reflectivity and high contract, and exhibits excellent and uniform display properties even if the LCD is used in high temperature and humidity environments and the two prism sheets are used in piles.

The adhesion layer 12 and the back layer 13 may contain a matting agent, a surfactant, and a lubricating agent as necessary.

A matting agent to be contained in the adhesion layer 12 and the back layer 13 may be organic or inorganic fine particles. Examples of such fine particles include polymer fine particles, for example, polystyrene, polymethylmethacrylate, silicone, and benzoguanamine polymer, and inorganic fine particles, for example, silica, calcium carbonate, magnesium oxide, and magnesium carbonate. Of those, polystyrene, polymethyl methacrylate, and silica are preferable in view of lubrication improvement effects and cost.

An average particle diameter of the matting agent is preferably at least 0.01 μm and at most 12 μm, and more preferably at least 0.03 μm and at most 9 μm. Using the matting agent with the average particle diameter within the above range provides the adhesion layer 12 and the back layer 13 sufficient lubrication improvement effects without reduction in image quality of a display. It should be noted that two or more kinds of matting agents having different average particle diameters from each other can be used.

Although an adding amount of matting agent differs depending on average particle diameter, the adding amount is preferably at least 0.1 mg/m² and at most 100 mg/m², and more preferably at least 0.5 mg/m² and at most 50 mg/m². Adding the matting agent with the amount within the above range provides the adhesion layer 12 and the back layer 13 sufficient lubrication improvement effects without reduction in image quality of a display.

Known anionic, nonionic, or cationic surfactants can be contained in the adhesion layer 12 and the back layer 13. Examples of surfactants are described in “A guidebook of surfactants” (edited by Ichiro Nishi et al, published by Sangyo Tosho, 1960). An adding amount of the surfactants is preferably at least 0.1 mg/m² and at most 30 mg/m², and more preferably at least 0.2 mg/m² and at most 10 mg/m². Adding the surfactant with the amount within the above range to the adhesion layer 12 and the back layer 13 prevents repelling thereon and makes their surface conditions excellent.

Examples of lubricating agents used in the adhesion layer 12 and the back layer 13 include synthesized or natural wax, a silicone compound, R—O—SO₃M. (“R” is substituted or unsubstituted alkyl group. The number of carbons in the alkyl group is an integer from 3 to 20. “M” is a monovalent metal atom.)

Examples of lubricating agents include wax type such as Cellosol 524, 428, 732-B, 920, B-495, Hydrin P-7, D-757, Z-7-30, E-366, F-115, D-336, D-337, Polylon A, 393, H-481, Hi-micron G-110F, 930, G-270 (trade names, all manufactured by CHUKYO YUSHI CO., LTD), Chemipearl W100, W200, W300, W400, W500, W950 (trade names, all manufactured by Mitsui Chemicals, Inc.), silicone type such as KF-412, 413, 414, 393, 859, 8002, 6001, 6002, 857, 410, 910, 851, X-22-162A, X-22-161A, X-22-162C, X-22-160AS, X-22-164B, X-22-164C, X-22-170B, X-22-800, X-22-819, X-22-820, X-22-821 (trade names, all manufactured by Shin-Etsu Chemical Co., Ltd.), and compounds represented by general formulae such as C₁₆H₃₃—O—SO₃Na and C₁₈H₃₇—O—SO₃Na. An adding amount of the lubricating agent is preferably at least 0.1 mg/m² and at most 50 mg/m², and more preferably, at least 1 mg/m² and at most 20 mg/m². Adding the lubricating agents with the amount within the above range to the adhesion layer 12 and the back layer 13 provides excellent surface conditions and sufficient lubrication properties.

[Prism Layer]

The prism layer 14 is provided to improve the front brightness of the backlight unit of the LCD. The prism layer 14 is made from acrylic UV cure polymer. The prism layer 14 has a structured surface on which prisms are formed in a pattern. Examples of the UV cure polymer include multifunctional (metha) acrylic compounds such as 2,4-dibromophenyl(meth)acrylate, 2,3,5-tribromophenyl(meth)acrylate, 2,2-bis(4-(meth)acryloyl oxyphenyl) propane, 2,2-bis(4-(meth)acryloyl oxyethoxyphenyl) propane, 2,2-bis(4-(meth)acryloyl oxydiethoxyphenyl)propane, 2,2-bis(4-(meth)acryloyl pentaethoxyphenyl)propane, 2,2-bis(4-(meth)acryloyl oxyethoxy-3,5-dibromophenyl)propane, 2,2-bis(4-(meth)acryloyl oxydiethoxy-3,5-dibromophenyl)propane, 2,2-bis(4-(meth)acryloyl oxypentaethoxy 3,5-dibromophenyl)propane, 2,2-bis(4-(meth)acryloyl oxyethoxy 3,5-dimethylphenyl)propane, 2,2-bis(4-(meth)acryloyl oxyethoxy-3-phenylphenyl)propane, bis(4-(meth)acryloyl oxyphenyl)sulfone, bis(4-(meth)acryloyl oxyethoxyphenyl)sulfone, bis(4-(meth)acryloyl oxypentaethoxyphenyl)sulfone, bis(4-(meth)acryloyl oxyethoxy 3-phenylphenyl)sulfone, bis(4-(meth)acryloyl oxyethoxy 3,5-dimethylphenyl)sulfone, bis(4-(meth)acryloyl oxyphenyl)sulfide, bis(methacryloyl thiopehnyl)sulfide, bis(4-(meth)acryloyl oxyethoxyphenyl)sulfide, bis(4-(meth)acryloyl oxypentaethoxyphenyl)sulfide, bis(4-(meth)acryloyl oxyethoxy-3-phenylphenyl)sulfide, bis(4-(meth)acryloyl oxyethoxy-3,5-dimethylphenyl)sulfide, di((meth)acryloyl oxyethoxy)phosphate, and tri((meth)acryloyl oxyethoxy)phosphate. The above-mentioned polymer can be used singly or in combination.

[Coating Methods of the Adhesion Layer and the Back Layer]

Coating methods for applying the adhesion layer 12 and the back layer 13 to the base layer 11 is not particularly limited. For example, known methods such as bar coater coating method or slide coater coating method can be used. A coating solvent may be water type or an organic solvent type. Examples of the water type coating solvent include water, toluene, methyl alcohol, isopropyl alcohol, methyl ethyl ketone, and a combination of the above. In view of cost and easiness in manufacture, water is preferably used as the coating solvent. It should be noted that the adhesion layer 12 and the back layer 13 are not applied to the not-yet-biaxially-stretched base layer 11 to perform the biaxial stretching. The adhesion layer 12 and the back layer 13 are applied to the biaxially-stretched base layer 11, namely, the base layer 11 has been biaxially stretched prior to the application of the adhesion layer 12 and the back layer 13. Thereby, the multilayer film 10 having uniform optical properties and excellent surface conditions are produced.

The coating is performed after the biaxial stretching of the base layer 11 so as to collect cut-off edges of the base layer 11 that has been stretched in the width (horizontal) direction. The first portion 12a and the second portion 12b of the adhesion layer 12 may be simultaneously applied and dried. Alternatively, the second portion 12b may be applied after the application and drying of the first portion 12a. For the sake of convenience in manufacture, the back layer 13 is applied on the back surface of the base layer 11 and dried during the application of the first portion 12a or the second portion 12b on the surface of the base layer 11.

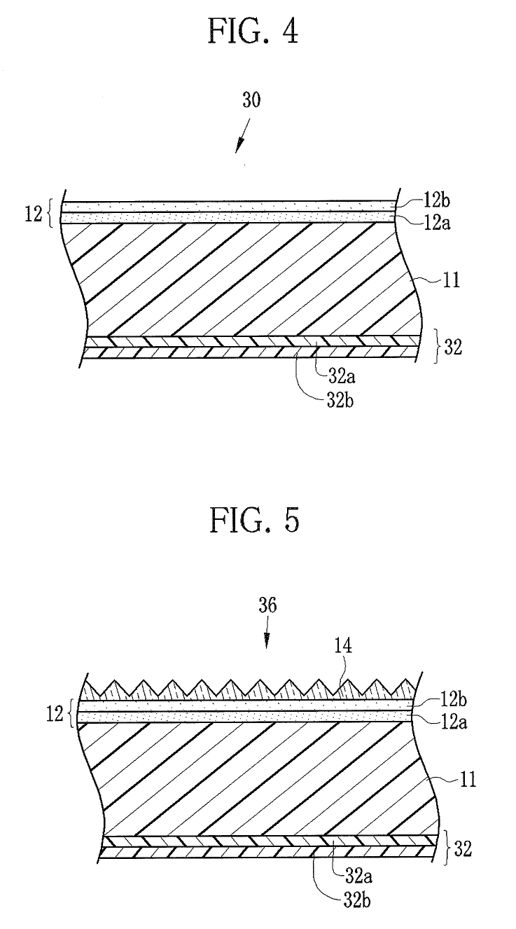

As shown in FIG. 4, a multilayer film 30 for use in a prism sheet according to a second embodiment of the present invention is the same as the multilayer film 10 except that the a back layer 32 is formed on the other surface of the base layer 11. The back layer 32 has a two-layer structure of an antistatic portion 32a and a low refractive index portion 32b in the thickness direction. The antistatic portion 32a and the low refractive index portion 32b are formed on the base layer 11 in this order. The low refractive index portion 32b is an outermost portion of the back layer 32, and exposed to air. As shown in FIG. 5, a prism sheet 36 according to the second embodiment of the present invention is the same as the prism sheet 15 according to the first embodiment except that the prism sheet 36 has the two-layer structure of the antistatic portion 32a and the low refractive index portion 32b on the other surface of the base layer 11. The two prism sheets 36, one stacked on top of the other, are incorporated in a display device such as an LCD. Since specific configurations of the multilayer film 30 and the prism sheet 36 are the same as those in the first embodiment except for the back layer 32, descriptions thereof are omitted.

[Antistatic Portion]

As with the back layer 13 in the first embodiment, the antistatic portion 32a contains thermoplastic polymer, that is, the binder as a main constituent. This thermoplastic polymer has glass transition temperature (Tg) of, preferably, at least 90° C., and more preferably at least 100° C. By setting the Tg at least 90° C. or at least 100° C., the contact damage caused by contact with the prism peaks does not occur even if the prism sheet is stacked on top of the other in high temperature environments. Water-insoluble polymer, for example, polymer soluble to organic solvent can be used as the binder of the antistatic portion 32a. Environmentally, latex polymer that is a water dispersion of a water-insoluble polymer is preferable. With the use of the binder made from water-insoluble polymer, the contact damage does not occur even in high humidity environments. Acrylic polymer having a high MMA content may be preferably used as the water-insoluble polymer having high Tg. Examples of latex polymer include co-polymerized polyester, aromatic polyurethane, and acrylic copolymer.

The antistatic portion 32a contains fine particles of metal oxides that exhibit conductivity by electronic conduction. Common metal oxides can be used as the fine particles. For example, ZnO, TiO₂, SnO₂, Al₂O₃, In₂O₃, MgO, BaO, MoO₃, a composite of them, and a metal oxide containing a small amount of a different kind of element in addition the above metal oxide. Of those, SnO₂, ZnO, TiO₂, and In₂O₃ are preferable, and SnO₂ is especially preferable. Alternatively, the antistatic portion 32a may contain π electron conjugated conductive polymer such as polythiophene polymer. Similar to the adhesion layer 12 and the back layer 13 according to the first embodiment, the antistatic portion 32a may contain a matting agent, a surfactant, and a lubricating agent as necessary.

In a case that the antistatic portion 32a contains metal oxide particles, the antistatic portion 32a preferably contains at least 50 wt. % and at most 500 wt. % of metal oxide particles relative to the binder, and more preferably contains at least 100 wt. % and at most 300 wt. %, and furthermore preferably contains at least 120 wt. % and at most 170 wt. %. By containing the metal oxide particles within the above range, the antistatic portion 32a exhibits the antistatic properties without coloring and reduction in scratch resistance. In a case that the antistatic portion 32a contains conductive polymer, the antistatic portion 32a preferably contains at least 1 wt. % and at most 20 wt. % of conductive polymer relative to the binder, and more preferably at least 3 wt. % and at most 10 wt. %, and furthermore preferably at least 4 wt. % and at most 8 wt. %. By containing the conductive polymer within the above range, the antistatic portion 32a exhibits antistatic properties without coloring and reduction in scratch resistance.

Examples of metal oxides containing a small amount of a different kind of element include, for example, ZnO doped with a small amount of Al or In, TiO₂ doped with a small amount of Nb or Ta, In₂O₃ doped with a small amount of Sn, and SnO₂ doped with a small amount of Sb, Nb, or a halogen element. SnO₂ particles doped with a small amount of Sb is especially preferable. A dope amount of a different kind of element doped to the metal oxide is preferably from 0.01 mol % to 30 mol %, and more preferably 0.1 mol % to 10 mol %. Doping the different kind of element in amount within the above range imparts the sufficient conductivity to the antistatic portion 32a without increase in blackening degree of the oxide particles.

It is preferable that metal oxide particles contained in the antistatic portion 32a are acicular in shape. Such metal oxide particles have higher probability of particle-to-particle contact when the antistatic portion 32a is applied in a form of a thin-film. Thereby, desired conductivity is achieved with only a small amount of the metal oxide particles. Such metal oxide particles are advantageous in view of cost and prevention of darkening. An average longer-axis length of the acicular metal oxide particles is preferably at least 0.01 μm and at most 0.5 μm, and more preferably at least 0.02 μm and at most 0.4 μm. Setting the average longer-axis length within the above range, the metal oxide particles are surely formed acicular in shape (acicular structure) while planarity of the antistatic portion 32a is maintained.

A ratio of the longer-axis length to the shorter-axis length of the acicular metal oxide particles is preferably at least 3 and at most 50, and more preferably at least 4 and at most 40. Setting the ratio within the above range improves the possibility of the contact between the metal oxide particles and ensures to form the metal oxide particles acicular in shape.

It is preferable that the antistatic portion 32a is formed such that the back layer 32 has surface resistance of at most 10¹² Ω/□, and more preferably at most 10¹¹ Ω/□. Setting the surface resistance to at most 10¹² Ω/□ or at most 10¹¹ Ω/□ imparts sufficient antistatic properties, making the prism sheet dust- and dirt-free.

In view of preventing reflection, the refractive index of the antistatic portion 32a at the wavelength of 550 nm is not particularly limited. However, it may be technically difficult to make the refractive index less than 1.2. In a case that the refractive index is higher than 1.70, on the other hand, scratch resistance of the coating layer may be impaired, which is undesirable.

The layer thickness of the antistatic portion 32a is preferably at least 30 nm and at most 120 nm, and more preferably at least 40 nm and at most 100 nm. Making the layer thickness within the above range ensures sufficient antistatic properties without reduction in scratch resistance and transparency. The layer thickness of the back layer 32, that is, the total layer thickness of the antistatic portion 32a and the low refractive index portion 32b is preferably in a range of at least (550/(4n*))−40 nm and at most (550/(4n*))+40 nm, more preferably in a range of at least (550/(4n*))−30 nm and at most (550/(4n*))+30 nm. “n*” is an average refractive index of the antistatic portion 32a and the back layer 32.

[Low Refractive Index Portion]

The low refractive index portion 32b has the same configuration as the back layer 13 of the first embodiment except for the layer thickness. The layer thickness of the low refractive index portion 32b is determined to satisfy the above range relative to the antistatic portion 32a. To prevent falling off of matting agent such as cross-linked acryl monodisperse particles added to the antistatic portion 32a without deterioration of surface conditions, the layer thickness of the low refractive index portion 32b is preferably at least 10 nm and at most 3000 nm, more preferably at least 20 nm and at most 1500 nm. Making the layer thickness within the above range ensures sufficiently low refractive properties without coloring problems caused by interference of light.

[Coating Methods of Adhesion Layer and Back Layer]

Methods for applying the adhesion layer 12 and the back layer 32 onto the base layer 11 are the same as those in the first embodiment, and the application thereof are carried out after the biaxial stretching of the base layer 11. The second portion 12b of the adhesion layer 12 is applied and dried after the first portion 12a is applied and dried. Similarly, the low refractive index portion 32b is applied and dried after the antistatic portion 32a is applied and dried. For the sake of convenience in manufacture, the first portion 12a of the adhesion layer 12 and the antistatic portion 32a are applied to the surface and the back surface of the base layer 11 respectively and dried, and then the second portion 12b of the adhesion layer 12 and the low refractive index portion 32b are applied onto the first portion 12a and the antistatic portion 32a respectively and dried.

In the above first and second embodiments, the adhesion layer 12 has the two-layer structure of the first portion 12a and the second portion 12b. A structure of the adhesion layer 12 is not limited to it. The adhesion layer 12 may have a single layer structure or a multilayer structure. For example, in a case that the adhesion layer 12 has a single layer structure, one of binders of the first portion 12a and the second portion 12b may be used as the binder for the single layer structure. Alternatively, a mixture or dispersion of the binders of the first portion 12a and the second portion 12b may be used as the binder. Even if the adhesion layer 12 has a single layer structure, it is preferable that the adhesion layer 12 contains the carbodiimide compound, the matting agent, the surfactant, and the lubricating agent described in the above embodiments.

In the second embodiment, the back layer 32 has the two-layer structure of the antistatic portion 32a and the low refractive index portion 32b, and the antistatic portion 32a is imparted with antistatic properties. Instead, the back layer 32 may have a single layer structure. In this case, the back layer 32 may contain at least one of metal oxide particles that exhibit conductivity by electronic conduction or π electron conjugated conductive polymer to reduce the surface resistance of the back layer 32 to at most 10¹² Ω/□. Alternatively or in addition, the first portion 12a or the second portion 12b of the adhesion layer 12 may contain one of metal oxide particles that exhibit conductivity by electronic conduction or π electron conjugated conductive polymer to reduce the surface resistance of the second portion 12b to at most 10¹² Ω/□.

### EXAMPLE 1

The present invention is furthermore detailed in the following examples and comparative examples. However, the present invention is not limited to the following.

[Base Layer]

Polyethylene terephthalate (hereinafter abbreviated as PET), synthesized by polycondensation using Ge compound as a main catalyst, with intrinsic viscosity of 0.66, was dried until the water content reaches 50 ppm or less. Then, the PET was melted in an extruder with the heater set in a temperature range from 280° C. to 300° C. The melted PET is discharged on a chill roll to which electrostatic voltage was applied from a die section. Thus, an amorphous base layer was obtained. The amorphous base layer was stretched 3.1 times the original size in a moving direction of the base layer, and 3.8 times the original size in a width direction thereof. Thus, the base layer 11 with the thickness of 125 μm was obtained.

[Adhesion Layer]

Corona discharge treatment was carried out to one of the surfaces of the base layer 11 (the average refractive index of 1.66 in its plane direction). A coating liquid X for forming the first portion 12a of the adhesion layer 12 was applied onto the base layer 11 using a bar coating method. The coating liquid X had the composition below. The applied amount was 7.1 cc/m². The applied coating liquid X was dried for one minute at 170° C. Thus, the first portion 12a of the adhesion layer 12 was formed on the base layer 11.

[Coating Liquid X for Forming First Portion]

| | |
|---|---|
| Polyester binder | 45.1 parts by mass |
| (manufactured by Goo Chemical Company, Ltd., trade name: Plas coat | |
| Z-687, solid content of 25 mass %, Tg = approximately 110° C.) | |
| Compound having a plurality of carbodiimide structures | 15.9 parts by mass |
| (manufactured by Nisshinbo Chemical Inc., trade name: Carbodilite | |
| V-02-L2, solid content of 40 mass %) | |
| Oxazoline compound | 7.1 parts by mass |
| (manufactured by Nippon Shokubai Co., Ltd., trade name: EPOCROS | |
| K-2020E, solid content of 40 mass %) | |
| Surfactant A | 12.7 parts by mass |
| (1 mass % aqueous solution of Rapizol B-90, manufactured by NOF | |
| corporation, anionic) | |
| Surfactant B | 15.5 parts by mass |
| (1 mass % aqueous solution of Naloacty CL-95, manufactured by | |
| Sanyo Chemical Industries, Ltd., nonionic) | |
| Distilled water | an amount to make the |
| | total 1000 parts by mass |

After the formation of the first portion 12a of the adhesion layer 12, corona discharge treatment was carried out on the first portion 12a. A coating liquid Y for forming the second portion 12b of the adhesion layer 12 was applied onto the first portion 12a using a bar coating method. The coating liquid Y had the composition below. The applied amount was 7.1 cc/m². The applied coating liquid Y was dried for one minute at 145° C. Thus, the second portion 12b of the adhesion layer 12 was formed on the base layer 11.

[Coating Liquid Y for Forming Second Portion]

| | |
|---|---|
| Acrylic polymer binder | 34.1 parts by mass |
| (manufactured by DAICEL CHEMICAL INDUSTRIES, LTD., trade name: | |
| EM 48D, solid content of 27.5 mass %, Tg = approximately 42° C.) | |
| Compound having a plurality of carbodiimide structures | 4.7 parts by mass |
| (manufactured by Nisshinbo Chemical Inc., trade name: Carbodilite | |
| V-02-L2, solid content of 40 mass %) | |
| Oxazoline compound | 7.1 parts by mass |
| (manufactured by Nippon Shokubai Co., Ltd., trade name: EPOCROS | |
| K-2020E, solid content of 40 mass %) | |
| Surfactant A | 12.5 parts by mass |
| (1 mass % aqueous solution of Rapizol B-90, manufactured by NOF | |
| corporation, anionic) | |
| Surfactant B | 15.5 parts by mass |
| (1 mass % aqueous solution of Naloacty CL-95, manufactured by | |
| Sanyo Chemical Industries, Ltd., nonionic) | |
| Dispersion liquid of silica fine particles | 1.6 parts by mass |
| (water dispersion of Aerosil OX-50, manufactured by Nippon | |
| Aerosil Co., Ltd., solid content of 10 mass %) | |
| Colloidal Silica | 0.6 parts by mass |
| (trade name: SNOWTEX XL, manufactured by Nissan Chemical | |
| Industries, Ltd., solid content of 40.5 mass %) | |
| Lubricating Agent | 1.6 parts by mass |
| (Cellosol 524, dispersion of Carnauba wax, produced by | |
| Chukyo-yushi Co, Ltd., solid content of 30 mass %) | |
| Preservative | 1.0 parts by mass |
| (methanol solution of 1,2-benzothiazolin-3-one, solid content of | |
| 3.5 mass %) | |
| Distilled water | an amount to make the |
| | total 1000 parts by mass |

[Back Layer]

After the formation of the adhesion layer 12 on one of the surfaces of the base layer 11, a coating liquid A for forming the back layer 13 was applied onto the other surface of the base layer 11 using a bar coating method. The coating liquid A had the composition below. The applied amount was 7.1 cc/m². The applied coating liquid A was dried for one minutes at 170° C. Thus, the back layer 13 with the layer thickness of approximately 90 nm was formed on the opposite side of the adhesion layer 12.

[Coating Liquid A for Forming Back Layer]

| | |
|---|---|
| Water dispersion of acrylic polymer binder represented by | 86.9 parts by mass |
| chemical formula 1 below. | |
| (solid content of 15 mass %, latex polymer, Tg = approximately | |
| 100° C.) | |
| Compound having a plurality of carbodiimide structures | 6.5 parts by mass |
| (manufactured by Nisshinbo Chemical Inc., trade name: Carbodilite | |
| V-02-L2, solid content of 40 mass %) | |
| Surfactant A | 17.6 parts by mass |
| (1 mass % aqueous solution of Rapizol B-90, manufactured by NOF | |
| corporation, anionic) | |
| Surfactant B | 21.5 parts by mass |
| (1 mass % aqueous solution of Naloacty CL-95, manufactured by | |
| Sanyo Chemical Industries, Ltd., nonionic) | |
| Dispersion liquid of silica fine particles | 0.2 parts by mass |
| (water dispersion of SEAHOSTER KE-W10, manufactured by Nippon | |
| Shokubai Co., Ltd., solid content of 15 mass %) | |
| Colloidal Silica | 0.9 parts by mass |
| (trade name: SNOWTEX XL, manufactured by Nissan Chemical | |
| Industries, Ltd., solid content of 40.5 mass %) | |
| Lubricating Agent | 2.2 parts by mass |
| (Cellosol 524, dispersion of Carnauba wax, produced by | |
| Chukyo-yushi Co, Ltd., solid content of 30 mass %) | |
| Distilled water | an amount to make the |
| | total 1000 parts by mass |

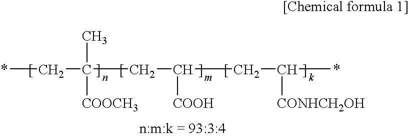

[Prism Layer]

After the formation of the adhesion layer 12 and the back layer 13 on the base layer 11, the coating liquid for forming the prism layer 14 was applied onto the adhesion layer 12 by the bar coating method using #24 bar. The coating liquid had the composition below. The applied coating liquid was dried for 3 minutes at 60° C. Then, a mold having a pattern for forming the prism layer 14 was pressed against the surface of the applied coating liquid, and UV light was irradiated thereto at 2000 mJ/cm² from the base layer 11 side using a metal halide lamp UVL-1500M2 manufactured by Ushio Inc., to cure the polymer (applied coating liquid). Thereafter, base layer 11 was peeled off from the mold. Thus, the prism sheet 15 having the prism layer 14 was produced. The prisms on the prism layer 14 have the prism peak angle of 90° and the height of 28 μm, and are arranged with 50 μm pitch.

[Prism Layer Coating Liquid]

| | |
|---|---|
| Compound represented by chemical formula 2 | 34.3 parts by mass |
| Compound represented by chemical formula 3 | 13.7 parts by mass |
| Compound represented by chemical formula 4 | 13.7 parts by mass |
| Compound represented by chemical formula 5 | 6.9 parts by mass |
| Compound represented by chemical formula 6 | 1.4 parts by mass |
| Methyl ethyl ketone | 15.0 parts by mass |
| Propylene glycol monomethyl acetate | 15.0 parts by mass |

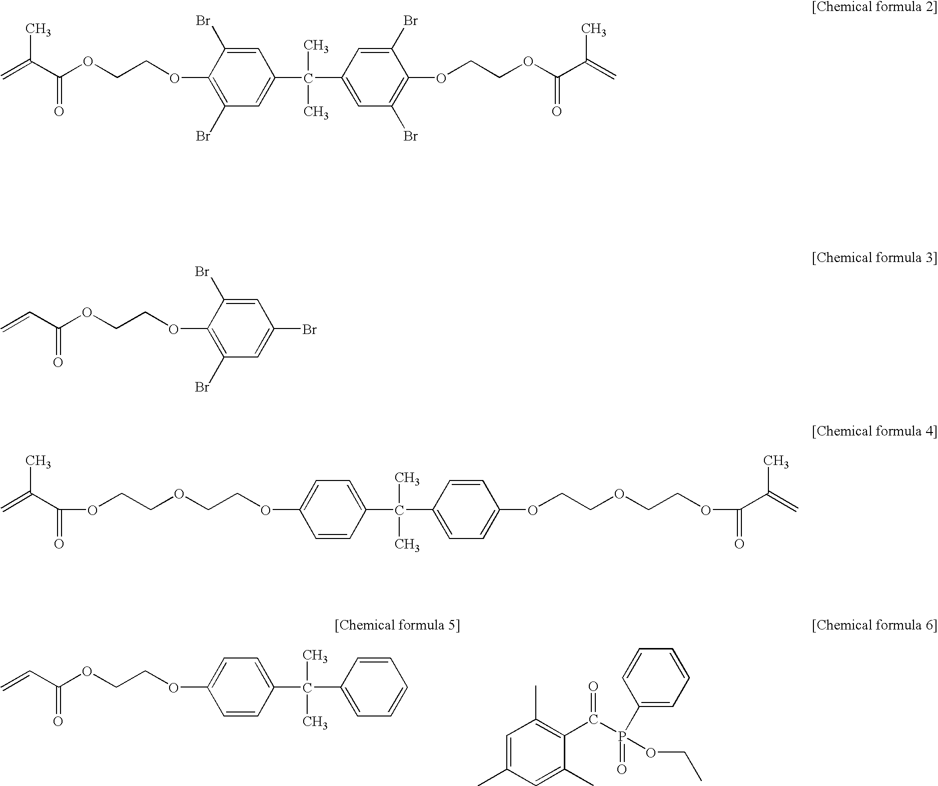

### EXAMPLE 2

As with the example 1, the first portion 12a and the second portion 12b of the adhesion layer 12 were formed on one of the surfaces of the base layer 11. Then, corona discharge treatment was carried out to the other surface of the base layer 11. Thereafter, a coating liquid B for forming the back layer 13 was applied onto the other surface using a bar coating method. The coating liquid B had the composition below. The applied amount was 7.1 cc/m². The applied coating liquid B was dried for one minute at 120° C. Thereby, the back layer 13 having the layer thickness of approximately 90 nm was formed on the opposite side of the adhesion layer 12. Then, as with the example 1, the prism layer 14 was formed on the adhesion layer 12.

[Coating Liquid B for Forming Back Layer]

| | |
|---|---|
| Acrylic polymer binder | 14.5 parts by mass |
| (trade name: DIANAL BR-87, manufactured | |
| by Mitsubishi Rayon Co., | |
| Ltd., Tg = approximately 105° C.) | |
| Dispersion liquid of silica fine particles | 15.5 parts by mass |
| (1 mass % MEK liquid dispersion of | |
| SEAHOSTER KE-P10, manufactured | |
| by Nippon Shokubai Co., Ltd.) | |
| Methyl ethyl ketone | an amount to make the |
| | total 1000 parts by mass |

### EXAMPLE 3

As with the example 1, the first portion 12a and the second portion 12b of the adhesion layer 12 were formed on one of the surfaces of the base layer 11. Then, corona discharge treatment was carried out to the other surface of the base layer 11. Thereafter, a coating liquid C for forming the antistatic portion 32a was applied onto the other surface using a bar coating method. The coating liquid C had the composition below. The applied amount was 6.1 cc/m². The applied coating liquid C was dried for one minute at 170° C. Thereby, the antistatic portion 32a having the layer thickness of approximately 70 nm was formed on the opposite side of the adhesion layer 12. Then, a coating liquid D for forming the low refractive index portion 32b was applied onto the antistatic portion 32a using the bar coating method. The coating liquid D had the composition below. The applied amount was 6.1 cc/m². The applied coating liquid D was dried for one minute at 145° C. Thereby, the low refractive index portion 32b having the layer thickness of approximately 40 nm was formed. Thereafter, as with the example 1, the prism layer 14 was formed on the adhesion layer 12. Thus, the prism sheet 36 was produced. It should be noted that “a ratio of longer-axis length/shorter-axis length” below and in the examples 5 and 9 indicates a ratio between the longer-axis length and the shorter-axis length of the metal oxide particles of average particle diameter contained in the coating liquid C.

[Coating Liquid C for Forming Antistatic Portion]

| | |
|---|---|
| Water dispersion of acrylic polymer binder represented by | 46.5 parts by mass |
| chemical formula 1 | |
| (solid content of 15 mass %, latex polymer, Tg = approximately | |
| 100° C.) | |
| Water dispersion of antimony-doped acicular SnO₂ | 50.2 parts by mass |
| (trade name: FS-10D, manufactured by Ishihara Techno Corporation, | |
| solid content of 20 mass %, ratio of longer-axis length/ | |
| shorter-axis length = 25) | |
| Compound having a plurality of carbodiimide structures | 7.0 parts by mass |
| (manufactured by Nisshinbo Chemical Inc., trade name: Carbodilite | |
| V-02-L2, solid content of 40 mass %) | |
| Surfactant A | 18.0 parts by mass |
| (1 mass % aqueous solution of Rapizol B-90, manufactured by NOF | |
| corporation, anionic) | |
| Surfactant B | 22.0 parts by mass |
| (1 mass % aqueous solution of Naloacty CL-95, manufactured by | |
| Sanyo Chemical Industries, Ltd., nonionic) | |
| Colloidal Silica | 0.7 parts by mass |
| (trade name: SNOWTEX XL, manufactured by Nissan Chemical | |
| Industries, Ltd., solid content of 40.5 mass %) | |
| Distilled water | an amount |
| | to make the total |
| | 1000 parts by mass |

[Coating Liquid D for forming low refractive index portion]

| | |
|---|---|
| Water dispersion of acrylic polymer binder represented by | 40.8 parts by mass |
| chemical formula 1 | |
| (solid content of 15 mass %, latex polymer, Tg = approximately | |
| 100° C.) | |
| Compound having a plurality of carbodiimide structures | 3.1 parts by mass |
| (manufactured by Nisshinbo Chemical Inc., trade name: Carbodilite | |
| V-02-L2, solid content of 40 mass %) | |
| Surfactant A | 16.6 parts by mass |
| (1 mass % aqueous solution of Rapizol B-90, manufactured by NOF | |
| corporation, anionic) | |
| Surfactant B | 20.4 parts by mass |
| (1 mass % aqueous solution of Naloacty CL-95, manufactured by | |
| Sanyo Chemical Industries, Ltd., nonionic) | |
| Dispersion liquid of silica fine particles | 0.2 parts by mass |
| (water dispersion of SEAHOSTER KE-W10, manufactured by Nippon | |
| Shokubai Co., Ltd., solid content of 15 mass %) | |
| Colloidal Silica | 0.4 parts by mass |
| (trade name: SNOWTEX XL, manufactured by Nissan Chemical | |
| Industries, Ltd., solid content of 40.5 mass %) | |
| Lubricating Agent | 3.1 parts by mass |
| (Cellosol 524, dispersion of Carnauba wax, produced by | |
| Chukyo-yushi Co, Ltd., solid content of 30 mass %) | |
| Distilled water | |
| | an amount to |
| | make the total |
| | 1000 parts by mass |

### EXAMPLE 4

Each portion was formed in the same manner as in the Example 3 except that a coating liquid E for forming the low refractive index portion 32b was used instead of the coating liquid D in forming the back layer 32, and the layer thickness of the low refractive index portion 32b was approximately 30 nm. The coating liquid E had the composition below.

[Coating Liquid E for Forming Low Refractive Index Portion]

| | |
|---|---|
| Polyolefin binder | 13.3 parts by mass |
| (Mitsui Chemicals Inc., Chemipearl S-120, solid content of 27 | |
| mass %) | |
| Compound having a plurality of carbodiimide structures | 3.2 parts by mass |
| (manufactured by Nisshinbo Chemical Inc., trade name: Carbodilite | |
| V-02-L2, solid content of 40 mass %) | |
| Surfactant A | 14.8 parts by mass |
| (1 mass % aqueous solution of Rapizol B-90, manufactured by NOF | |
| corporation, anionic) | |
| Surfactant B | 18.2 parts by mass |
| (1 mass % aqueous solution of Naloacty CL-95, manufactured by | |
| Sanyo Chemical Industries, Ltd., nonionic) | |
| Colloidal Silica | 8.8 parts by mass |
| (trade name: SNOWTEX XL, manufactured by Nissan Chemical | |
| Industries, Ltd., solid content of 20 mass %) | |
| Distilled water | an amount to make the |
| | total 1000 parts by mass |

### EXAMPLE 5

Each portion was formed in the same manner as in the example 1 except that a coating liquid Z1 for forming the first portion 12a of the adhesion layer 12 was used instead of the coating liquid X. The coating liquid Z1 had the composition below.

[Coating Liquid Z1 for Forming First Portion]

| | |
|---|---|
| Polyester binder | 45.1 parts by mass |
| (manufactured by Goo Chemical Company, Ltd., trade name: Plas coat | |
| Z-687, solid content of 25 mass %, Tg = approximately 110° C.) | |
| Compound having a plurality of carbodiimide structures | 15.9 parts by mass |
| (manufactured by Nisshinbo Chemical Inc., trade name: Carbodilite | |
| V-02-L2, solid content of 40 mass %) | |
| Oxazoline compound | 7.1 parts by mass |
| (manufactured by Nippon Shokubai Co., Ltd., trade name: EPOCROS | |
| K-2020E, solid content of 40 mass %) | |
| Water dispersion of antimony-doped acicular SnO₂ | 77.5 parts by mass |
| (trade name: FS-10D, manufactured by Ishihara Techno Corporation, | |
| solid content of 20 mass %, ratio of longer-axis length/ | |
| shorter-axis length = 25) | |
| Surfactant A | 12.7 parts by mass |
| (1 mass % aqueous solution of Rapizol B-90, manufactured by NOF | |
| corporation, anionic) | |
| Surfactant B | 15.5 parts by mass |
| (1 mass % aqueous solution of Naloacty CL-95, manufactured by | |
| Sanyo Chemical Industries, Ltd., nonionic) | |
| Distilled water | an amount to make the |
| | total 1000 parts by mass |

### EXAMPLE 6

Each portion was formed in the same manner as in the example 1 except that a coating liquid Z2 for forming the second portion 12b of the adhesion layer 12 was used instead of the coating liquid Y. The coating liquid Z2 had the composition below.

[Coating Liquid Z2 for Forming Second Portion]

| | |
|---|---|
| Acrylic polymer binder | 34.1 parts by mass |
| (manufactured by DAICEL CHEMICAL INDUSTRIES, LTD., trade name: | |
| EM 48D, solid content of 27.5 mass %, Tg = approximately 42° C.) | |
| Compound having a plurality of carbodiimide structures | 4.7 parts by mass |
| (manufactured by Nisshinbo Chemical Inc., trade name: Carbodilite | |
| V-02-L2, solid content of 40 mass %) | |
| Oxazoline compound | 7.1 parts by mass |
| (manufactured by Nippon Shokubai Co., Ltd., trade name: EPOCROS | |
| K-2020E, solid content of 40 mass %) | |
| Polythiophene compound | 47.2 parts by mass |
| (trade name: Orgacon HBS, manufactured by Agfa Geveart Japan, Ltd., | |
| solid content 1.2 mass % aqueous solution) | |
| Aqueous solution of sodium hydroxide | 22.6 part by mass |
| (solid content of 0.4 mass %) | |
| Surfactant A | 12.5 parts by mass |
| (1 mass % aqueous solution of Rapizol B-90, manufactured by NOF | |
| corporation, anionic) | |
| Surfactant B | 15.5 parts by mass |
| (1 mass % aqueous solution of Naloacty CL-95, manufactured by | |
| Sanyo Chemical Industries, Ltd., nonionic) | |
| Dispersion liquid of silica fine particles | 1.6 parts by mass |
| (water dispersion of Aerosil OX-50, manufactured by Nippon | |
| Aerosil Co., Ltd., solid content of 10 mass %) | |
| Colloidal Silica | 0.6 parts by mass |
| (trade name: SNOWTEX XL, manufactured by Nissan Chemical | |
| Industries, Ltd., solid content of 40.5 mass %) | |
| Lubricating Agent | 1.6 parts by mass |
| (Cellosol 524, dispersion of Carnauba wax, produced by | |
| Chukyo-yushi Co, Ltd., solid content of 30 mass %) | |
| Preservative | 1.0 parts by mass |
| (methanol solution of 1,2-benzothiazolin-3-one, solid content of | |
| 3.5 mass %) | |
| Distilled water | an amount to make the |
| | total 1000 parts by mass |

### EXAMPLE 7

Each portion was formed in the same manner as in the example 3 except that the low refractive index portion 32b was not formed on the antistatic portion 32a of the back layer 13, and the layer thickness of the antistatic portion 32a was approximately 70 nm.

### EXAMPLE 8

Each portion was formed in the same manner as in the example 3 except that a coating liquid F for forming the low refractive index portion 32b was used instead of the coating liquid D, and the layer thickness of the low refractive index portion 32b was approximately 40 nm. The coating liquid F had the composition below.

[Coating Liquid F for Forming the Low Refractive Index Portion]

| | |
|---|---|
| Polyester binder | 21.0 parts by mass |
| (trade name: Finetex ES-650, manufactured by Dainippon Ink & | |
| Chemicals, Inc., solid content of 29%,) | |
| Compound having a plurality of carbodiimide structures | 3.1 parts by mass |
| (manufactured by Nisshinbo Chemical Inc., trade name: Carbodilite | |
| V-02-L2, solid content of 40 mass %) | |
| Surfactant A | 16.6 parts by mass |
| (1 mass % aqueous solution of Rapizol B-90, manufactured by NOF | |
| corporation, anionic) | |
| Surfactant B | 20.4 parts by mass |
| (1 mass % aqueous solution of Naloacty CL-95, manufactured by | |
| Sanyo Chemical Industries, Ltd., nonionic) | |
| Dispersion liquid of silica fine particles | 0.2 parts by mass |
| (water dispersion of SEAHOSTER KE-W10, manufactured by Nippon | |
| Shokubai Co., Ltd., solid content of 15 mass %) | |
| Colloidal Silica | 0.4 parts by mass |
| (trade name: SNOWTEX XL, manufactured by Nissan Chemical | |
| Industries, Ltd., solid content of 40.5 mass %) | |
| Lubricating Agent | 3.1 parts by mass |
| (Cellosol 524, dispersion of Carnauba wax, produced by | |
| Chukyo-yushi Co, Ltd., solid content of 30 mass %) | |
| Distilled water | an amount to make the |
| | total 1000 parts by mass |

### EXAMPLE 9

Each portion was formed in the same manner as in the example 3 except that a coating liquid G for forming the antistatic portion 32a was used instead of the coating liquid C, and a coating liquid H for forming the low refractive index portion 32b was used instead of the coating liquid D, and the thickness of the low refractive index portion 32b was approximately 750 nm. The coating liquids G and H had the compositions below.

[Coating Liquid G for Forming Antistatic Portion]

| | |
|---|---|
| Water dispersion of acrylic polymer binder represented by | 365.4 parts by mass |
| chemical formula 1 | |
| (solid content of 15 mass %, latex polymer, Tg = approximately | |
| 100° C.) | |
| Water dispersion of antimony-doped acicular SnO₂ | 394.4 parts by mass |
| (trade name: FS-10D, manufactured by Ishihara Techno Corporation, | |
| solid content of 20 mass %, ratio of longer-axis length/ | |
| shorter-axis length = 25) | |
| Compound having a plurality of carbodiimide structures | 55.2 parts by mass |
| (trade name: Carbodilite V-02-L2, manufactured by Nisshinbo | |
| Chemical Inc., solid content of 40 mass %) | |
| Surfactant A | 9.0 parts by mass |
| (2 mass % aqueous solution of Rapizol B-90, manufactured by NOF | |
| corporation, anionic) | |
| Surfactant B | 4.0 parts by mass |
| (5 mass % aqueous solution of Naloacty CL-95, manufactured by | |
| Sanyo Chemical Industries, Ltd., nonionic) | |
| Cross-linked acrylic monodisperse particle A | 75.0 parts by mass |
| (trade name: MX-1500, manufactured by Soken Chemical & | |
| Engineering Co., Ltd., average particle diameter: 15 μm, | |
| monodisperse type) | |
| Cross-linked acrylic monodisperse particle B | 50.0 parts by mass |
| (trade name: MX-350 α, manufactured by Soken Chemical & | |
| Engineering Co., Ltd., average particle diameter: 3.5 μm) | |
| Distilled water | |
| | an amount to make |
| | the total |
| | 1000 parts by mass |

[Coating Liquid H for forming low refractive index portion]

| | |
|---|---|
| Water dispersion of acrylic polymer binder represented by | 652.8 parts by mass |
| chemical formula 1 | |
| (solid content of 15 mass %, latex polymer, Tg = approximately | |
| 100° C.) | |
| Compound having a plurality of carbodiimide structures | 49.6 parts by mass |
| (manufactured by Nisshinbo Chemical Inc., trade name: Carbodilite | |
| V-02-L2, solid content of 40 mass %) | |
| Surfactant A | 132.8 parts by mass |
| (2 mass % aqueous solution of Rapizol B-90, manufactured by NOF | |
| corporation, anionic) | |
| Surfactant B | 65.3 parts by mass |
| (5 mass % aqueous solution of Naloacty CL-95, manufactured by | |
| Sanyo Chemical Industries, Ltd., nonionic) | |
| Dispersion liquid of silica fine particles | 3.2 parts by mass |
| (water dispersion of SEAHOSTER KE-W10, manufactured by Nippon | |
| Shokubai Co., Ltd., solid content of 15 mass %) | |
| Colloidal Silica | 6.4 parts by mass |
| (trade name: SNOWTEX XL, manufactured by Nissan Chemical | |
| Industries, Ltd., solid content of 40.5 mass %) | |
| Lubricating Agent | 49.6 parts by mass |
| (Cellosol 524, dispersion of Carnauba wax, produced by | |
| Chukyo-yushi Co, Ltd., solid content of 30 mass %) | |
| Distilled water | |
| | an amount to make |
| | the total |
| | 1000 parts by mass |

### COMPARATIVE EXAMPLE 1

The first portion 12a and the second portion 12b of the adhesion layer 12 were formed on one of the surfaces of the base layer 11 as in the example 1. Thereafter, the prism layer 14 was formed on the adhesion layer 12 as in the example 1. However, the antistatic portion 32a and the back layer 13 were not formed unlike the examples 1 to 9.

### COMPARATIVE EXAMPLE 2

Each portion was formed in the same manner as in the Example 1 except that a coating liquid I for forming the back layer 13 was used instead of the coating liquid A, and the layer thickness of the back layer 13 was approximately 100 nm. The coating liquid I had the composition below.

[Coating Liquid I for Forming Back Layer]

| | |
|---|---|
| Polyester binder | 58.0 parts by mass |
| (manufactured by Goo Chemical Company, Ltd., trade name: Plas coat | |
| Z-687, solid content of 25 mass %, water-soluble, Tg = | |
| approximately 110° C.) | |
| Compound having a plurality of carbodiimide structures | 7.1 parts by mass |
| (manufactured by Nisshinbo Chemical Inc., trade name: Carbodilite | |
| V-02-L2, solid content of 40 mass %) | |
| Surfactant A | 12.7 parts by mass |
| (1 mass % aqueous solution of Rapizol B-90, manufactured by NOF | |
| corporation, anionic) | |
| Surfactant B | 15.5 parts by mass |
| (1 mass % aqueous solution of Naloacty CL-95, manufactured by | |
| Sanyo Chemical Industries, Ltd., nonionic) | |
| Dispersion liquid of silica fine particles | 1.6 parts by mass |
| (water dispersion of Aerosil OX-50, manufactured by Nippon | |
| Aerosil Co., Ltd., solid content of 10 mass %) | |
| Colloidal Silica | 0.6 parts by mass |
| (trade name: SNOWTEX XL, manufactured by Nissan Chemical | |
| Industries, Ltd., solid content of 40.5 mass %) | |
| Lubricating Agent | 1.6 parts by mass |
| (Cellosol 524, dispersion of Carnauba wax, produced by | |
| Chukyo-yushi Co, Ltd., solid content of 30 mass %) | |
| Distilled water | an amount to make the |
| | total 1000 parts by mass |

### COMPARATIVE EXAMPLE 3

Each portion was formed in the same manner as in the example 1 except that a coating liquid J for forming the back layer 13 was used instead of the coating liquid A, and the layer thickness of the back layer 13 was approximately 100 nm. The coating liquid J had the composition below.

[Coating Liquid J for Forming Back Layer]

| | |
|---|---|
| Acrylic polymer binder | 53.0 parts by mass |
| (manufactured by DAICEL CHEMICAL INDUSTRIES, LTD., trade name: | |
| EM 48D, solid content of 27.5 mass %, latex polymer, Tg = | |
| approximately 42° C.) | |
| Compound having a plurality of carbodiimide structures | 6.5 parts by mass |
| (manufactured by Nisshinbo Chemical Inc., trade name: Carbodilite | |
| V-02-L2, solid content of 40 mass %) | |
| Surfactant A | 17.5 parts by mass |
| (1 mass % aqueous solution of Rapizol B-90, manufactured by NOF | |
| corporation, anionic) | |
| Surfactant B | 17.5 parts by mass |
| (1 mass % aqueous solution of Naloacty CL-95, manufactured by | |
| Sanyo Chemical Industries, Ltd., nonionic) | |
| Dispersion liquid of silica fine particles | 2.1 parts by mass |
| (water dispersion of Aerosil OX-50, manufactured by Nippon | |
| Aerosil Co., Ltd., solid content of 10 mass %) | |
| Colloidal Silica | 0.9 parts by mass |
| (trade name: SNOWTEX XL, manufactured by Nissan Chemical | |
| Industries, Ltd., solid content of 40.5 mass %) | |
| Lubricating Agent | 2.1 parts by mass |
| (Cellosol 524, dispersion of Carnauba wax, produced by | |
| Chukyo-yushi Co, Ltd., solid content of 30 mass %) | |
| Distilled water | an amount to make the |
| | total 1000 parts by mass |

### COMPARATIVE EXAMPLE 4

As with the example 1, the first portion 12a and the second portion 12b of the adhesion layer 12 were formed on one of the surfaces (top surface) of the base layer 11. In the same manner, the first portion 12a and the second portion 12b of the adhesion layer 12 were formed on the other surface (back surface) of the base layer 11 in this order on the base layer 11. Thereafter, the prism layer 14 was formed on the adhesion layer 12 on the top surface. The layer thickness of the second portion 12b of the adhesion layer on the back surface was approximately 85 nm.

[Evaluation]

Following evaluations were performed on the prism sheets produced in the examples 1 to 9 and the comparative examples 1 to 4.

[Tg of Binder]

Tg of polymer, that is, Tg of a binder (main binder) having the largest parts by mass of all the binders contained in the back layer 13 was measured using a differential scanning calorimeter (abbreviated as DSC, trade name: DSC-60, manufactured by Shimadzu) at the temperature rise speed of 10° C./min.

[Layer Thickness]

The layer thickness of a sample was measured using a transmission electron microscope (abbreviated as TEM, trade name: JEM2010, manufactured by JEOL Ltd.) with magnification of 200000 times. The sample was the base layer 11 onto which only the adhesion layer 12 was applied.

[Refractive Index of the Coating Layer]

The coating liquids A, B, C, D, E, F, H, I, J and Y for forming an outermost portion of the back layer (back outermost portion) were applied onto silicon wafers, respectively, with dry layer thickness of at least 3 μm and at most 4 μm. Each applied coating liquid was dried for 10 minutes at 105° C. Thus, samples were made. The refractive index of each sample was measured at wavelengths of 660 nm, 850 nm, 1310 nm, 1550 nm by prism coupler method using SPA-400 (trade name, manufactured by Sairon Technologies, Inc.). The refractive index of each sample at the wavelength of 550 nm was obtained based on the measured refractive indices and the wavelengths, using Celmaire formula.

[Reflectivity of Back Layer]

A black magic marker (trade name: Artline, oil-based refill ink KR-20 black, manufactured by Shachihata Inc.) was used to color the surface of the multilayer film for use in a prism sheet on the adhesion layer 12 side. This multilayer film is provided with a back layer. The colored surface was dried. Thus, a pretreatment sample having transparency of at most 1% at 500 nm wavelength was made. An absolute reflectivity of the pretreatment sample was measured using a UV/VIS spectrophotometer (trade name: V-550 manufactured by JASCO Corporation) and an absolute reflectivity measuring device (trade name: ARV-474, JASCO Corporation) under the following conditions: an incident angle of 5° (degrees), a wavelength range from 380 nm and 780 nm, a sampling pitch of 1 nm, a slit a width of 2 nm, scan speed 200 nm/sec., and medium response. In addition, an average absolute reflectivity at a wavelength range from 380 nm to 780 nm of the pretreatment sample was calculated.

[Total Light Transmittance]

Total light transmittance of the multilayer films 10 and 30 for use in the prism sheet was measured using a haze meter (trade name: NDH-2000, manufactured by Nippon Denshoku Industries Co., Ltd.) in conformance with JIS K 7105.

[Brightness]

Front brightness of the prism sheet on the prism layer 14 side was measured in a state that the produced prism sheet was placed on a diffusion plate of a direct-type backlight unit composed of a reflection sheet, a cold-cathode tube, and the diffusion plate. The front brightness was measured using a spectrum analyzer (trade name: BM-7, manufactured by Topcon Technohouse Corporation). The brightness of the direct-type backlight unit without the prism sheet was defined as 100%. A percentage of brightness increase caused by placing the prism sheet on the direct-type backlight unit was evaluated according to the following criteria.

A: brightness increase was 152% or more

B: brightness increase was at least 150% and less than 152%

F: brightness increase was less than 150%

[Surface Resistance]

Surface resistance SR (Ω/□) of the multilayer films, that is, the multilayer films 10 and 30 for use in a prism sheet obtained in the examples and the comparative examples were measured based on a method described in “resistivity” in JIS K 6911 (1979). The multilayer film was left in an atmosphere at a temperature of 23° C. and 65% RH for six hours to control the moisture. Then, in the same atmosphere, the resistivity of the multilayer film was measured using a constant-voltage power supply (trade name: TR-300C, manufactured by Advantest Corporation), an ammeter (trade name: TR-8651, manufactured by Advantest Corporation), and a sample chamber (TR-42, Advantest Corporation). In the examples 1 to 9 and the comparative examples 1 to 4, the surface resistance of the second portion 12b of the adhesion layer was measured. In the examples 1 to 9 and the comparative examples 2 to 4, the surface resistance of the outermost portion of the back layer was measured. In the comparative example 1, the surface resistance of the back surface of the base layer 11 was measured.

[Adhesion with the Prism Layer]

On the surface of the prism layer 14, a lattice pattern of 25 squares with six cuts in horizontal and vertical directions is made using a single-edged razor. A width between the cuts was 3 mm both in the horizontal and the vertical directions. An adhesive cellophane tape was put on the lattice and then rubbed with an eraser such that the adhesive cellophane tape is completely adhered to the lattice. Thereafter, the adhesive cellophane tape was peeled at 90° (degrees) to the prism layer 14, and the peeled squares of the prism layer 14 were counted. Ranking was determined by the number of the peeled squares.

Rank A: the number of the peeled squares was zero

Rank B: the number of the peeled squares was less than one

Rank C: the number of the peeled squares was one or more and less than 3

Rank D: the number of the peeled squares was 3 or more and less than 20

Rank E: the number of the peeled squares was 20 or more

It should be noted that evaluation was carried out without forming the prism shape on the prism layer 14, because the prism shape lowers the adhesion between the adhesive cellophane tape and the prism layer 14.

[Contact Damage Caused by Contact with Prism Peaks]

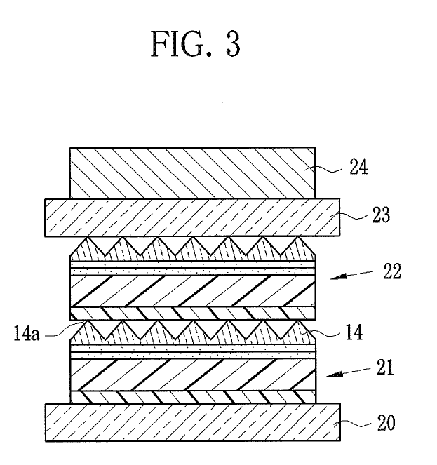

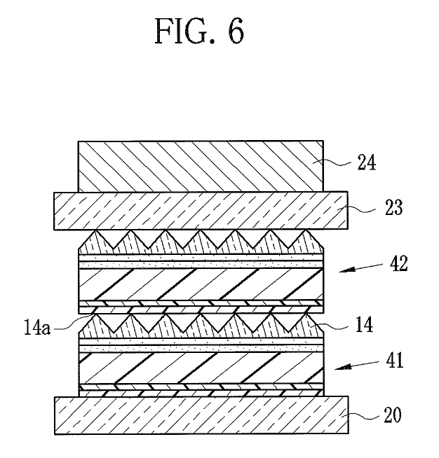

In the examples 1, 2, 5 to 7 and the comparative examples 1 to 3, as shown in FIG. 3, two prism sheets 21 and 22 were placed with one stacked on top of the other on a glass plate 20. On the prism sheet 22, a glass plate 23 was placed. A load 24 of 1 kgf/10 cm² (that is, 9.8×10³ Pa in SI unit) was applied onto the glass plate 23 such that the prism layer 14 of the prism sheet 21 contacts with the back surface of the prism sheet 22 (the back layer 13 in the examples 1, 2, 5, and 6, the antistatic portion 32a in the example 7, the base layer 11 in the comparative example 1, and the back layer in the comparative examples 2 and 3.) Similarly, in the examples 3, 4, 8, and 9 and the comparative example 4, as shown in FIG. 6, the prism sheets 41 and 42 are placed with one stacked on top of the other on the glass plate 20, and the glass plate 23 was placed on the prism sheet 42. The load 24 of 1 kgf/10 cm² was applied onto the glass plate 23 such that the prism layer 14 of the prism sheet 41 contacts with the back surface of the prism sheet 42 (the low refractive index portion 32b in the examples 3, 4, 8, and 9, and the layer made from the coating liquid Y in the comparative example 4).

The prism sheets and the loads are left under thermo conditions at 80° C. dry and 80° C. with 80% RH for 48 hours. Thereafter, each prism sheet 22 was taken out, and the back surface thereof was observed visually and with a microscope (×100 field of view) The contact damage (streak-like grooves) caused by contact with the prism peaks 14a of the prism layer 14 was ranked according to the following criteria. It should be noted that the numeral 14a is assigned to a part of the prism peaks in FIGS. 3 and 6.

A: No contact damage was observed by both visible and microscopic inspections

B: No contact damage was observed by visible inspection, but the contact damage was observed by microscopic inspection

F: Contact damage was observed by both visual and microscopic inspections

[Results]

The above evaluation results are shown in Tables 1-1, 1-2, and 2. In the following tables, surface resistance SR is indicated by common logarithm (Log SR (Ω/□)). The examples 1 to 9 are abbreviated as EX1 to EX9, respectively. The comparative examples 1 to 4 are abbreviated as COM 1 to COM 4.

TABLE 1-1

| | | EX 1 | EX 2 | EX 3 | EX 4 | EX 5 | EX 6 | EX 7 | EX 8 | EX 9 |
|---|---|---|---|---|---|---|---|---|---|---|
| AL | 1^{st} | CL X | CL X | CL X | CL X | CL Z1 | CL X | CL X | CL X | CL X |
| | portion | | | | | | | | | |
| | 2^{nd} | CL Y | CL Y | CL Y | CL Y | CL Y | CL Z2 | CL Y | CL Y | CL Y |
| | portion | | | | | | | | | |
| BL | ASP | CL A | CL B | CL C | CL C | CL A | CL A | CL C | CL C | CL G |
| | LRIP | | | CL D | CL E | | | | CL F | CL H |

| | | | | | | | | | |
|---|---|---|---|---|---|---|---|---|---|
| Tg (° C.) | 100 | 105 | 105 | 100 | 100 | 100 | 100 | 100 | 100 |
| of | | | | | | | | | |
| main | | | | | | | | | |
| binder | | | | | | | | | |
| in BL | | | | | | | | | |
| solubility | WIL | WI | WIL | WIL | WIL | WIL | WIL | WIL | WIL |
| of | | | | | | | | | |
| main | | | | | | | | | |
| binder | | | | | | | | | |
| in BL | | | | | | | | | |
| BOP | 90 | 90 | 40 | 30 | 90 | 90 | 70 | 40 | 750 |
| thickness | | | | | | | | | |
| (nm) | | | | | | | | | |
| BOP RI | 1.50 | 1.50 | 1.50 | 1.48 | 1.50 | 1.50 | 1.56 | 1.56 | 1.50 |
| BL average | 2.4% | 2.6% | 3.4% | 3.3% | 2.4% | 2.4% | 3.9% | 4.0% | 4.2% |
| reflectivity | | | | | | | | | |
| Total | 94.9% | 94.6% | 93.8% | 94.0% | 94.4% | 94.6% | 93.4% | 93.3% | 93.4% |
| light | | | | | | | | | |
| transmittance | | | | | | | | | |

TABLE 1-2

| | | EX 1 | EX 2 | EX 3 | EX 4 | EX 5 | EX 6 | EX 7 | EX 8 | EX 9 |
|---|---|---|---|---|---|---|---|---|---|---|
| Brightness | | A | A | A | A | A | A | B | B | B |
| SR | SA | 15.2 | 15.2 | 15.2 | 15.2 | 9.7 | 9.9 | 15.2 | 15.2 | 15.2 |
| Log | SB | 15.6 | 15.8 | 9.9 | 10.2 | 15.6 | 15.6 | 9.9 | 10.2 | 11.5 |
| SR | | | | | | | | | | |
| (Ω/□) | | | | | | | | | | |
| UV | SA | A | A | A | A | A | A | A | A | A |
| cure | | | | | | | | | | |
| polymer adhesion | | | | | | | | | | |
| property | | | | | | | | | | |
| PPCD | SB | A | A | A | A | A | A | A | A | A |
| 80° C. | | | | | | | | | | |
| Dry | | | | | | | | | | |
| PPCD | | A | A | A | A-B | A | A | A | A-B | A |
| 80° C. | | | | | | | | | | |
| 80% RH | | | | | | | | | | |

TABLE 2

| | | COM 1 | COM 2 | COM 3 | COM 4 |
|---|---|---|---|---|---|
| AL | 1^{st} portion | CL X | CL X | CL X | CL X |
| | 2^{nd} portion | CL Y | CL Y | CL Y | CL Y |
| BL | ASP | | CL I | CL J | (CL X) |
| | LRIP | | | | (CL Y) |
| Tg (° C.) of main binder in BL | | — | 110 | 42 | 110 |
| solubility of main binder in BL | | — | WS | WIL | WS |
| BOP thickness (nm) | | — | 100 | 100 | 85 |
| BOP RI | | — | 1.60 | 1.50 | 1.50 |
| BL average reflectivity | | 6.1% | 4.7% | 2.6% | 3.9% |
| Total light transmittance | | 91.7% | 92.9% | 94.8% | 93.5% |
| Brightness | | F | B | A | B |
| SR Log SR (Ω/□) | SA | 15.2 | 15.2 | 15.2 | 15.2 |
| | SB | 15.8 | 15.6 | 15.0 | 15.2 |
| UV cure polymer | SA | A | A | A | A |
| adhesion property | | | | | |
| PPCD 80° C. Dry | SB | A | A | B | B |
| PPCD 80° C. 80% RH | | A | F | F | F |

Following abbreviations are used in Tables 1-1, 1-2, and 2. AL: adhesive layer, BL: back layer, CL: coating liquid, ASP: antistatic portion, LRIP: low refractive index portion, WIL: water-insoluble latex, WI: water insoluble, WS: water soluble, BOP: back outermost portion (outermost portion of back layer), RI: refractive index, SR: surface resistance, SA: exposed surface of adhesion layer, SB: exposed surface of back layer, PPCD: Contact damage caused by prism peaks
It should be noted that Tg (° C.) of the main binder in BL is an approximate value.

As shown in the Tables 1-1 and 1-2, in the examples 1 to 9, the main binders of the back layers 13 and 32 have the Tg of at least 90° C., and contain water-insoluble thermoplastic polymer. As a result, the back layers 13 and 32 were free from the contact damage.

In the examples 1 to 6, the average reflectivity of the back layers 13 and 32 at wavelength in a range from 380 nm to 780 nm was at most 3.5%. As a result, the brightness was enhanced by 152% and above. In the example 4, the average reflectivity was slightly reduced by changing the binder contained in the low refractive index portion 32b of the example 3 from “acrylic polymer binder” to “polyolefin binder”.

In the examples 3, 4, 7, 8, and 9, metal oxide fine particles were contained in the antistatic portion 32a. In the example 5, metal oxide was contained in the first portion 12a of the adhesion layer 12. In the example 6, polythiophene compound was contained in the second portion 12b of the adhesion layer 12. As a result, the surface resistances of the back layers 13 and 32, and the second portion 12b of the adhesion layer 12 ware reduced to at most 10¹² □/Ω (at most “12” when converted to common logarithm), preventing adhesion of the foreign matter to the prism sheet.

On the contrary, as shown in the Table 2, in comparative example 1, the back layers 13 and 32 were not provided unlike the examples 1 to 9. As a result, brightness enhancement properties were not obtained. Moreover, the antistatic portion was not provided unlike the examples 3 to 9. As a result, the surface resistance exceeds 10¹² Ω/□, causing adhesion of foreign matter to the prism sheet.

In the comparative example 2, although the main binder of the back layer has high Tg, it is made from water-soluble polymer. As a result, in high humidity environments, the contact damage remained on the back layer. In the comparative example 2, the brightness enhancement properties were not obtained due to the high refractive index of the back layer.

In the comparative example 3, the average refractive index is reduced to at most 3.5%. As a result, the brightness enhancement properties were obtained. However, the main binder of the back layer has low Tg even though it was made from water-insoluble polymer. As a result, the contact damage remained on the back layer.

In the comparative example 4, the main binder of the back layer was made from water-soluble polymer. As a result, the contact damage remained on the back layer in high humidity environments. In the comparative example 4, antistatic properties and sufficient brightness enhancement properties were not obtained even though the adhesion layers 12 were provided on both surfaces of the base layer 11.

Various changes and modifications are possible in the present invention and may be understood to be within the present invention.

What is claimed is:

1. A multilayer film for use in a prism sheet having a prism layer, comprising:
a biaxially-stretched base layer made from polyester;
an adhesion layer provided on a surface of said base layer, said adhesion layer being adhesive to said prism layer; and
a back layer provided on the other surface of said base layer, said back layer containing water-insoluble thermoplastic polymer as a main constituent, glass transition temperature (Tg) of said thermoplastic polymer being at least 90° C.

2. The multilayer film of claim 1, wherein said back layer has average reflectivity of at most 3.5% at a wavelength range from 380 nm to 780 nm.

3. The multilayer film of claim2, wherein a refractive index n of said back layer is at least 1.20 and at most 1.51.

4. The multilayer film of claim 3, wherein at least one of said back layer and said adhesion layer has conductivity expressed in terms of surface resistance of at most 10¹² Ω/□.

5. The multilayer film of claim 4, wherein at least one of said back layer and said adhesion layer contains metal oxide particles.

6. The multilayer film of claim 4, wherein at least one of said back layer and said adhesion layer contains conductive polymer.

7. The multilayer film of claim 1, wherein said back layer is composed of plural portions overlaid in layers in a thickness direction, and an outermost portion of said back layer is exposed to air and has a refractive index n of at least 1.20 and at most 1.51.

8. The multilayer film of claim 7, wherein said back layer is composed of an antistatic portion layered on said other surface of said base layer and a low refractive index portion layered on said antistatic portion, and said antistatic portion has conductivity expressed in terms of surface resistance of at most 10¹² Ω/□, and said low refractive index portion is said outermost portion.

9. A method for producing a multilayer film for use in a prism sheet having a prism layer, said method comprising the steps of:
preparing a biaxially-stretched base layer made from polyester; and
applying an adhesion layer adhesive to said prism layer onto one of surfaces of said base layer, and applying a back layer onto the other surface of said base layer, said back layer containing water-insoluble thermoplastic polymer as a main constituent, glass transition temperature (Tg) of said thermoplastic polymer being at least 90° C.

10. A prism sheet comprising:
a biaxially-stretched base layer made from polyester;
an adhesion layer provided on a surface of said base layer;
a prism layer provided on said adhesion layer, said adhesion layer being adhesive to said prism layer;
a back layer provided on the other surface of said base layer, said back layer containing water-insoluble thermoplastic polymer as a main constituent, glass transition temperature (Tg) of said thermoplastic polymer being at least 90° C.

11. A display device comprising:
a multilayer film for use in a prism sheet having a prism layer, said multilayer film including:
a biaxially-stretched base layer made from polyester;
an adhesion layer provided on a surface of said base layer, said adhesion layer being adhesive to said prism layer; and
a back layer provided on the other surface of said base layer, said back layer containing water-insoluble thermoplastic polymer as a main constituent, glass transition temperature (Tg) of said thermoplastic polymer being at least 90° C.
